(19) United States
(12) Patent Application Publication
(10) Pub. No.: US 2011/0310318 A1
(43) Pub. Date: Dec. 22, 2011

(54) LIQUID CRYSTAL SHUTTER GLASSES

(75) Inventor: Kenichi Kawagoe, Suzuka-Shi (JP)

(73) Assignee: MJ LABORATORY JAPAN CO., LTD., Nichinan-shi, Miyazaki (JP)

(21) Appl. No.: 13/201,060

(22) PCT Filed: Feb. 5, 2010
(86) PCT No.: PCT/JP2010/051667

§ 371 Date: Aug. 11, 2011

(30) Foreign Application Priority Data
Feb. 12, 2009 (JP) 2009-029662
Sep. 11, 2009 (JP) 2009-210840

(51) Int. Cl. G02F 1/1335

(52) U.S. Cl. 349/13

(57) ABSTRACT

[Solutions] LCD shutter lens eye glasses 1 equipped with a frame 10, including left/right arms 12R, 12L for a purpose of wearing human head part, LCD lens 20 which switches between transparent and semi-transparent stage, and a controller 30, which controls LCD lens switching between transparent and semi-transparent stage. Controller 30 consists of control circuit board 31A and battery 32, which supplies power to control circuit board 31A, and controls LCD lens 20 to switch between transparent and semi-transparent stage. Control circuit board 31A is built in either left or right side of frame 10, and battery 32 is built in opposite side.

[Selected Figure] FIG. 1

### CATEGORY OF TECHNOLOGY

This invention is regarding LCD shutter lens eye glasses

### TECHNOLOGICAL BACKGROUND

In most of all sports, ability to observe object and quick response are required, and variety of training methods have been studied to improve such capabilities. As an example, strobe training, which uses strobe light in a dark room to light an object intermittently, has been known. Said situation makes a trainee to feel the object moving slower than actual speed, and compels trainee's quicker reaction.

Said method requires large dark room, which limits the location and availability. In order to resolve such problem, an apparatus like the one shown in Patent Documents No. 1, which is equipped with LCD lenses that alternatively switch between transparent and opaque stage at the set frequency, has been known to simulate strobe light in a dark room for dynamic vision training.

Also, an apparatus with a similar function shown in Patent Documents 2 was invented for the specific application of Pachi-Slo [Pachinko-Slot-machine] assistance device.

The application of above mentioned apparatuses is not limited to sports vision training and Pachi-Slo machines, but to wider variety of applications, such as inspection of engines and other high RPM rotating machinery, observation of other moving objects, etc.

### PREVIOUS TECHNOLOGICAL DOCUMENTS

### Patent Documents

[Patent Documents No. 1] Toku Hyo Hei No. 9-510371 Official Bulletins
[Patent Documents No. 2] Toku Kai No. 2004-81755 Official Bulletins

### SUMMARY OF INVENTION

### Themes this Invention Attempts to Resolve

The construction of apparatuses shown by Patent Documents No. 1 and No. 2, FIG. 2, which have a separate wired control box, is inconvenient for sports training and/or competition purposes as the wire may get in the motion. On the other hand, patent documents No. 2 FIG. 2 shows an apparatus with a controller built into its left arm, which eliminates the problem of wiring between control box and a frame. However, such design creates another situation, which is weight allocation unbalance that may prevent trainee's concentration. Everyone's head is uniquely shaped. When an apparatus is used for athletic training, comfortable and well-fitting superior wear-ability is vital

According to such considerations described above, the purpose of this invention is to provide a pair of eye glasses with LCD shutter lenses which can be worn comfortably.

### Measure to Resolve the Theme

This invention proposes a pair of eye glasses consists of a frame and right/left arms, which holds an apparatus in position, right/left LCD lenses, a controller built into one of the arms, which switches right/left LCD lenses simultaneously to transparent and semi-opaque state alternatively, and a battery for the controller built into another arm, which is a unique and advantageous feature.

By building a controller device into one of the two arms, and a battery compartment into another arm, the wiring between all units does not expose outside of an apparatus, and the weight balance is well maintained. Such design provides comfort of wearing with a user and would not distract concentration during the training or competition. A battery compartment means either battery itself or detachable battery case.

A frame of apparatus may be equipped with an adjustable nose pad, of which the parallel distance between the frame and the pad is adjusted by rotating built in screw.

Such adjustable nose pad easily provides most comfortable fitting to multiple users, and enables to use the same apparatus among different trainees at sports gyms, golf training schools, etc. where multiple people use one apparatus.

LCD lenses of apparatus are designed to be transparent when the power is off. This feature is convenient to the use, because his/her view is not blocked when not in use, and may keep wearing an apparatus when it is not in use.

Aforementioned LCD shutter lens uses TN type LCD, and is designed to be transparent when the power is off, and opaque state may be designed to be semi-transparent. When the power is off and the lenses are in transparent state, certain amount of light is still interrupted, thus the apparatus functions as a pair of sunglasses. This feature will be convenient to use for outdoor sports.

In addition, aforementioned control circuit board of an apparatus is equipped with a built in wireless signal receiver which enables the apparatus capable of receiving control signals transmitted from a separate controller unit. This feature enables a user to control the apparatus with a controller on his/her wrist.

### Effect of Invention

Aforementioned LCD shutter lens eye glasses are featured with built-in control circuitry on one arm, and a power source (battery) on another arm, which will provide good static balance of the entire apparatus, and an adjustable nose pad, which will provide the most comfortable fitting to multiple users.

### BRIEF EXPLANATIONS OF DRAWINGS

FIG. 1 External slant front view of the LCD shutter glasses

FIG. 2 External slant back exploded view of the LCD shutter glasses

FIG. 3 Wiring diagram of the LCD shutter glasses

FIG. 4 Electronics block diagram of the control unit

FIG. 5 Nose pad adjustment descriptions

FIG. 6 External slant view of the remote control type LCD shutter glasses

FIG. 7 Block diagram of electronics construction for the LCD shutter glasses controller unit

### IMPLEMENTATION OF INVENTION

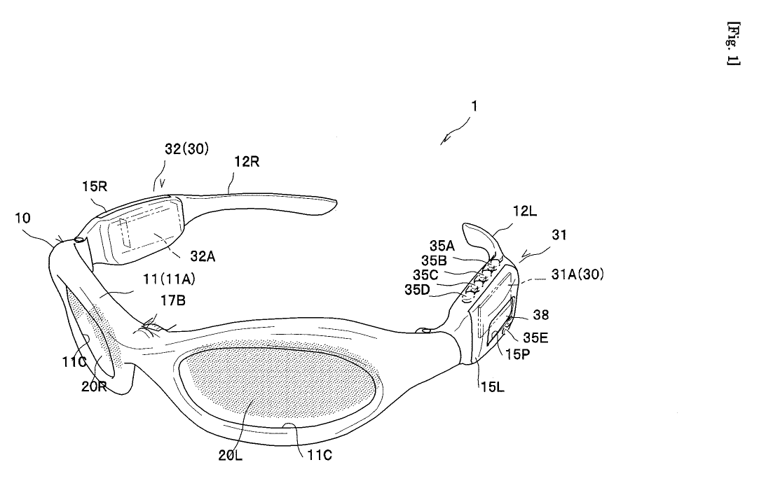

To follow are explanations with drawings for implementation of invention. As shown by FIG. 1, the LCD shutter glasses 1 consists of frame 10, LCD lenses 20 (20R, 20L) and controller 30.

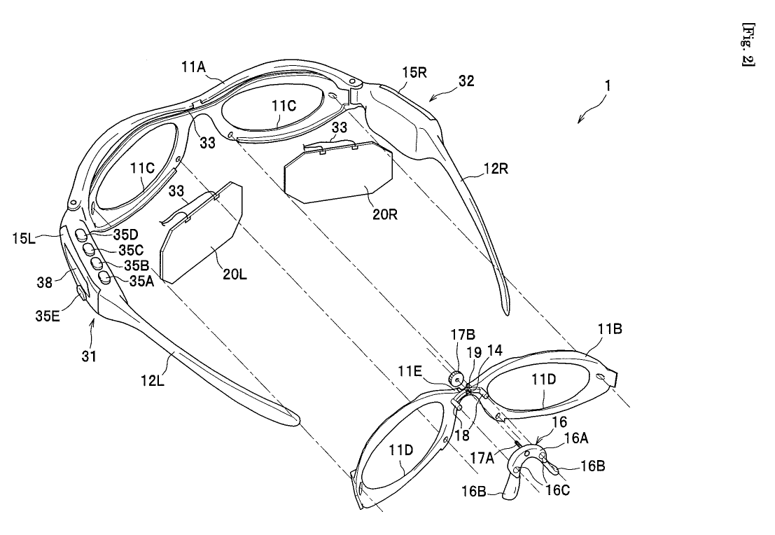

Similar to regular eye glasses, Frame 10 consists of rim (main part) 11, left arm 12L and right arm 12R. As shown by FIG. 2, rim 11 consists of front rim 11A and rear rim 11B which are combined by small screws (not shown), and a space for wire harness 33 is formed between front rim 11A and rear rim 11B. In this documents, front/rear, left/right and up/down are relative to user's front/rear, left/right and up/down.

Same as regular eye glasses, front rim 11A has an opening space 11C for a lens (LCD lens 20 is used in this implementation), and rear rim 11B also has an opening 11D to match with 11C.

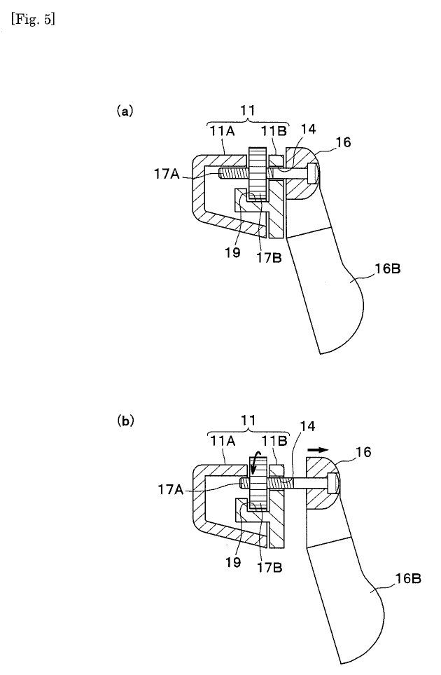

A nose pad #16 is mounted on a bridge 11E of rear rim 11B. Two pins 18 are mounted and extruding on the rear of bridge 11E. Nose pad 16 consists of main part #16A and two extended parts 16B. Main part 16A has through holes 16C for two pins 18. The pad assembly is mounted on two pins 18 with the holes 16C, hence the assembly can slide on pins 18. A screw shaft 17A is installed in the middle of nose pad main part 16A towards front. The screw shaft 17A is inserted into shaft hole 14 located in the middle of rear rim 11B together with a nut 17B. The nut 17A has a disc shape, and its top part is partly exposed and extruded from the top of rim 11 as shown by FIG. 1. The nut 17B is held inside recessed part of 19 located on a bridge 11E of rear rim 11B. The movement in front and rear direction of a nut 17B is restricted by front and rear two walls as shown by FIG. 5(a). The screw shaft 17A and nut 17B are examples of screw materials.

As shown by FIG. 1, left arm 12L has a compartment for control circuit board 31A located in the temple area when it is worn as a complete device. The compartment 31 has a cover 15L, which is fixed by a small screw not shown in drawings. Removable cover 15L has a small opening, through which display 38 mounted on control circuit board 31A is viewed. The control circuit board compartment 31 is equipped with operating switches 35A-35E connected to control circuit board 31A, which are exposed externally.

Right arm 12R has a box shaped battery compartment 32, which includes battery 32A, symmetrically to the control circuitry compartment 31. Battery compartment 32 has a removable cover 15R, which will be fixed by a small screw not shown in drawings.

LCD lens 20 is a TN type panel, which is designed to be in transparent stage when the power is off, and in semi-transparent stage when power is on. LCD lens 20 is, as shown by FIG. 2, formed in octagonal shape, with control wires 33 attached on its top, which go into open space formed in upper part of rim 11.

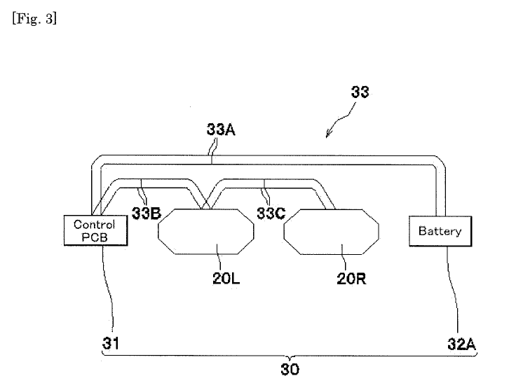

As shown by FIG. 3, control circuit board 31A of control unit 30 is located in left arm 12L, and attached to wiring cable 33A, which comes from a battery in right arm 12R to supply power. Then, control signal will be sent from control circuit board 31A to heft LCD lens 20L through wiring cable 33B, and to right LCD lens 20R through wiring cable 33C.

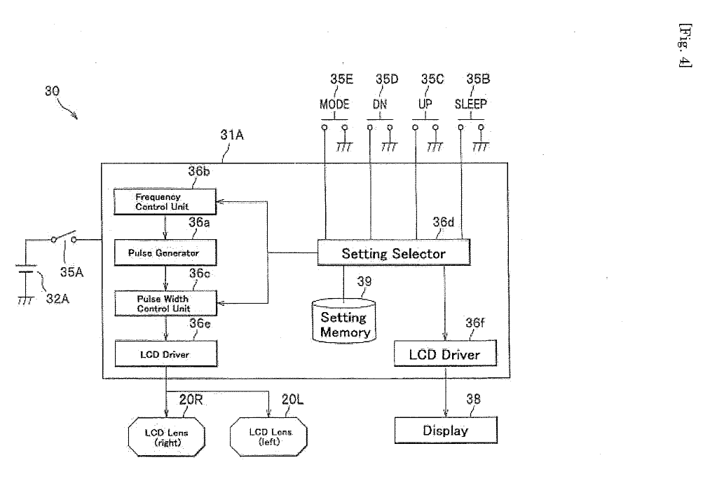

As shown by FIG. 4, control unit 30 is powered by battery 32A to its control circuit board 31A through main switch 35A.

Control circuit board 31A includes pulse oscillator 36a, frequency controller 36b, pulse width controller 36c, setting part 36d, LCD driver 36e, 36f and setting memory 39.

Setting memory 39 memorizes and holds preset name, pulse duty ratio and frequency combinations. As an example, setting F01 memorizes duty ratio 50%, etc. Duty ratio can be, for instance, set from 50% to 95% at 5% increment. Frequency can be, for instance, set from 2 to 500 Hz at appropriate increment. Setting memory 39 memorizes a setting at the time sleep switch 35B is depressed.

Sleep switch 35B, down switch 35D, up switch 35C and mode switch 35E are connected to setting part 36d. Mode switch 35E alternatively switches between duty ratio setting mode and frequency setting mode every time it is depressed; in duty ratio setting mode, down switch 35D and up switch 35C change duty ratio setting downward and upward respectively, and read setting name and respective duty ratio from memory 39. When mode is switched to frequency setting mode by depressing 35E, down switch 35D and up switch 35C change frequency setting downward and upward respectively, and read setting name and respective frequency from memory 39.

Read out duty ratio is sent to pulse width controller 36c, and frequency to frequency controller 36b. Hence, frequency controller unit 36b changes pulse signal frequency generated by pulse generator 36a. Then, pulse signal generated by pulse generator 36a is sent to pulse width controller 36c, and required pulse width signal is sent to LCD driver 36e.

LCD driver 36e amplifies pulse signal voltage from pulse width controller 36c to drive LCD lens 20R and 20L.

At the same time, a setting name read out from 36d is sent to LCD driver 36f, and displayed on display panel 38. As described above, when sleep switch 35B is depressed while LCD shutter lens glasses 1 is in operation, setting 36d commands memory 39 to memorize current settings, and stops pulse generator 36a, frequency controller 36b, pulse width controller 36c, setting 36d and LCD driver 36e and 36f. When sleep switch 35B is depressed again while sleeping, device reads out memorized settings and resumes the same operation when it was suspended. When main switch 35A is depressed and power is turned off while sleeping, memory 39 resets memorized setting, and the device starts with a preset setting instead.

To follow are explanations how LCD shutter lens glasses 1, of which the constructions are described above, function.

A user wears LCD shutter lens glasses 1 on the face in the same manner as normal eye glasses, then depresses main switch 35A to turn on power to control circuit board 31A. Control circuit board 35A, then reads out default duty ratio (preset under a name F01) and default frequency (preset under a name 005), and sends these values to pulse width control unit 36c and frequency control unit 36b. Frequency control unit 36b modifies pulse frequency generated by pulse generator 36a accordingly, and sends it to pulse width control unit 365c. Pulse width control unit 36c sends pulse signal at specified width to LCD driver 36e. LCD driver 36e modifies voltage of input signal from 36c to appropriate value for LCD lens 20 to function and sends equivalent signal to both left and right LCD lens 20R and 20L.

Hence, left and right LCD lenses 20R, 20L simultaneously switch between transparent and semi-transparent stage alternatively, which is referred to as blinking. This enables wearer of LCD shutter lens glasses 1 to visualize object intermittently, and performs athletic training or observes moving object, like checking machinery movement.

When a user desires to change duration of semi-transparent stage in each cycle, depress either up switch 35C or down switch 35D. This will command setting selection unit 36d reads different duty ratio out from setting memory 39. When user desires to change frequency depending on the object, depress mode switch 35E to turn the controller into frequency mode, then depress either up switch 35C or down switch 35D. This will command setting selection unit 36d to read different frequency out from memory 39. These read out values are memorized in setting memory unit 39. Then, frequency controller 36b, pulse generator 36a, pulse width controller 36c and LCD driver 36e drive both left and right LCD lenses 20L, 20R simultaneously according to the selected values.

Accordingly, both duty ratio and frequency of afore mentioned LCD shutter lens glasses are able to be set at suitable values to characteristics of a moving object.

Afore mentioned LCD shutter lens glasses 1 has relatively heavy battery 32A and control circuit board 31A in right arm 12R and left arm 12L respectively, which provides superior right and left weight balance to users. Future advancement of technology may make either or both battery and control unit smaller and lighter in weight, but weight balance of the glasses would still be unfavorable if both units are built in one arm. The allocation of these units of LCD shutter lens glasses 1; which is each one unit in one arm, guarantees the best weight balance and comfort when it is worn, and prevents destruction especially from athletes in action.

When a user desires to adjust position of nose pad 16, rotate a nut 17B as shown in FIG. 5(a) and (b). When nut 17B is rotated, screw shaft 17A is moved against rim 11, because front/rear walls of recessed space 19 and front rim 11A restrict location of nut 17B. As a result, nose pad 16 incorporated with screw shaft 17A is moved either closer or farther against LCD lenses plane. This enables front/rear direction adjustment of nose pad 16, which adjusts distance between users face and LCD lenses 20 planes. Different from generally used adjustment by bending nose pad holder wires, this rotary type adjustment enables frequent adjustment, which is advantageous for the case multiple users use one LCD shutter lens glasses 1, like for rental or lease.

Lenses 20 of LCD shutter lens glasses 1 are designed to be in transparent stage when the power is off, which enables users to continue to wear when the operation is suspended. This feature will prevent users from taking off the device every time the operation is suspended.

The application of this invention is not limited to afore mentioned contents, and will be able to be widely applied with its adjustable features.

For example, LCD lenses 20 may be set at semi-transparent stage when the power is off by appropriately adjusting direction of polarized panel which are used in combination with liquid crystal module panel. In this case, it is recommended to use TN type LCD panel and polarized panels to locate them in an appropriate direction to make it semi-transparent as a lens. These lenses of semi-transparent stage with no power may be used as sunglasses, which is suitable to outdoor sports, as an example,

Appropriate transparency ratio for visual effect of semi-transparent stage in this case would be 5%-50%, more specifically 5%-30%, and perhaps 5%-20% may be the most suitable for the purpose.

In order to obtain left/right weight balance of afore mentioned LCD shutter lens glasses, battery 32A and control circuit board 31A are built into left and right arm 12R/12L. For better weight balance, additional ballast weight may be added to either battery 32A or control circuit board 31A, whichever a lighter weight side.

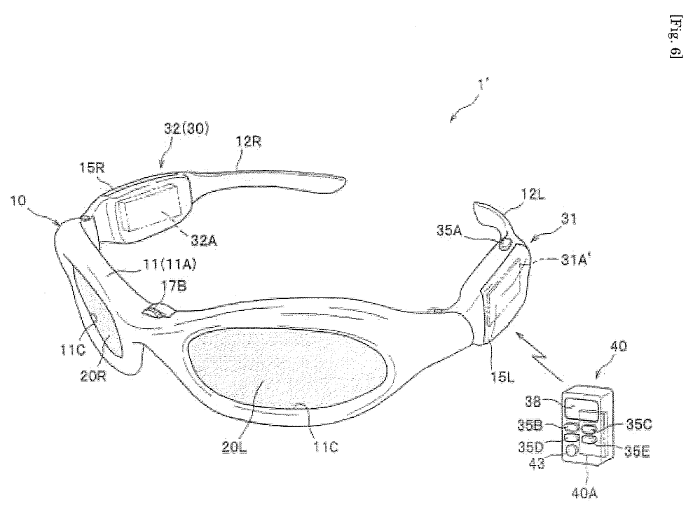

All controls and a display are integrated and built in arm 12L in aforementioned LCD shutter lens glasses 1, but this invention does not limit to such design. As shown by FIG. 6, as an example, remote control method may be applied. Actually, LCD shutter lens glasses 1′ shown in FIG. 6 is modified from aforementioned LCD shutter lens glasses 1 by removing switch 35B-35E, display 38 and a part of control circuit board 31A (LCD driver 36f, etc.). If such removal of switch 35B-35E causes unbalanced left/right weight, additional ballast weight may be added to left arm 12L to resolve the problem.

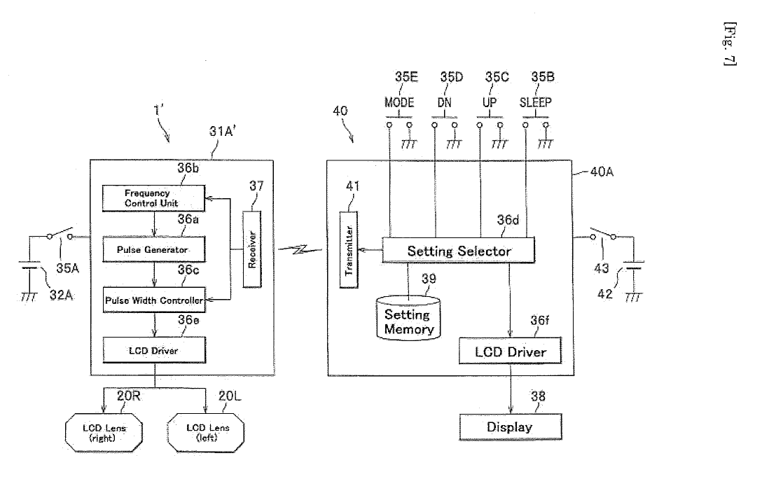

Those removed switches 35B-35E and other parts are included in a controller unit 40 separate from LCD shutter lens glassed 1′. Actually, as shown by FIG. 7, controller unit 40 has switch 35B-35E, setting selection part 36d, LCD driver 36f, setting memory 39 and display 38, all equivalent to aforementioned functions. Control circuit board 40A, equipped with setting selection part 36d etc. also includes transmitter 41, which transmits various data read out by setting selection part 36d from setting memory 39 to receiver 37 built in LCD shutter lens glasses 1′. Controller 40 includes battery 42 which powers control circuit board 40A, and main switch 43 which turns on and off of power supply to control circuit board 40A.

Control circuit board 31A of LCD shutter lens glasses 1′ includes frequency control unit 36b, pulse generator 36a, pulse width controller 36c and LCD driver 36e, as well as receiver 37 which receives wireless signal from controller 40. Receiver 37 is designed to submit signals to frequency control unit 36b and pulse width control unit 36c, which enables LCD shutter lens glasses 1′ to be controlled by wireless signals from controller 40.

Such design simplifies construction of LCD shutter lens glasses, and decreases total weight. Also, user is able to manipulate the glasses by looking at display and switches 35B-35E on his/her wrist, which will significantly improve maneuverability.

Aforementioned design uses left/right LCD lenses 20R/20L for LCD shutter glasses 1, but this invention is not limited to dual lenses; when this invention is applied to a left and right side combined single lens design, single LCD lens may be used. In such case, total wiring may be decreased.

Aforementioned design specifies left and right LCD lenses 20R/20L simultaneously switch between transparent and semi-transparent stages, but this invention is not limited to such design, For example, right side LCD lens stays at semi-transparent stage, whole left LD lens switches between two stages.

Aforementioned design specifies control circuit board 31A and battery 32 to be built into left and right arm 12L/12R respectively, but this invention is not limited to such design. Control circuit board 31A ad battery 32 may be built into left side and right side of frame 10. For example, control circuit board may be built into one side of rim 11, and battery into opposite side.

However, left and right outer side of rim 11 has limited space for such installation. Right and left arm would provide sufficient space for such built-in, especially for a battery to have larger capacity. It is advantageous to build in control circuit board near front end of the arm (closer to rim), because it will provide better maneuverability and protection of control circuit board compartment and battery compartment, which may interfere when arms are folded.

### EXPLANATION OF INDICATIONS

1 LCD shutter lens glasses
10 Frame
16 Nose pad
17A Screw shaft
17B Nut
20 (20R, 20L) LCD lenses
30 Control unit
31 Circuit board compartment
31A Control circuit board
32 Battery compartment
32A Battery
33 Wiring cable
35A Main switch
35B Sleep switch
35C Up switch
35D Down switch
35E Mode switch

1. LCD shutter lens eye glasses featured with a frame, including left/right arm, to wear on human head part and
LCD lens that can be switched between transparent and limited transparent stage, installed in the said frame,
equipped with a controller which switches said LCD lens between transparent and limited transparent stage, and
said controller that includes control circuit board and a battery to supply power to the control circuit board, which controls the said LCD lens between transparent and limited transparent stage,
said control circuit board that is built in either left or right side, and a battery is built in another side.

2. LCD shutter lens eye glasses described in claim 1 featured with aforementioned frame including a nose pad with a set of screw components that enabled distance between said nose pad and LCD lenses plane adjustable.

3. LCD shutter lens eye glasses described in claim 1 featured with aforementioned LCD lens designed to be in transparent stage when the power is off.

4. LCD shutter lens eye glasses described in claim 1 featured with TN type LCD lens designed to be in limited transparent stage when the power is off, and limited transparent means semi-transparent.

5. LCD shutter lens eye glasses described in claim 1, featured with aforementioned control circuit board, equipped with a receiving device which receives wireless signal from a controller unit separate from aforementioned LCD shutter lens eye glasses that enables controlling its function with wireless signals from aforementioned controller.

6. LCD shutter lens eye glasses described in claim 2 featured with aforementioned LCD lens designed to be in transparent stage when the power is off.

7. LCD shutter lens eye glasses described in claim 2 featured with TN type LCD lens designed to be in limited transparent stage when the power is off, and limited transparent means semi-transparent.

8. LCD shutter lens eye glasses described in claim 2, featured with aforementioned control circuit board, equipped with a receiving device which receives wireless signal from a controller unit separate from aforementioned LCD shutter lens eye glasses that enables controlling its function with wireless signals from aforementioned controller.

9. LCD shutter lens eye glasses described in claim 3, featured with aforementioned control circuit board, equipped with a receiving device which receives wireless signal from a controller unit separate from aforementioned LCD shutter lens eye glasses that enables controlling its function with wireless signals from aforementioned controller.

10. LCD shutter lens eye glasses described in claim 4, featured with aforementioned control circuit board, equipped with a receiving device which receives wireless signal from a controller unit separate from aforementioned LCD shutter lens eye glasses that enables controlling its function with wireless signals from aforementioned controller.
